(19) United States
(12) Patent Application Publication
(10) Pub. No.: US 2005/0112233 A1
(43) Pub. Date: May 26, 2005

(54) Method for conditioning animals

(76) Inventors: Raymond Clifford Noble, Ayr (GB); Paul Charles Penny, East Yorkshire (GB)

Correspondence Address: HESLIN ROTHENBERG FARLEY & MESITI PC, 5 COLUMBIA CIRCLE, ALBANY, NY, 12203, US

(21) Appl. No.: 10/818,447

(22) Filed: Apr. 5, 2004

Related U.S. Application Data
(63) Continuation of application No. PCT/GB02/04440, filed on Oct. 2, 2002.

(30) Foreign Application Priority Data
Oct. 3, 2001 (GB) 0123827.8

(51) Int. Cl. A01K 1/00

(52) U.S. Cl. 426/2

(57) ABSTRACT

A method of conditioning an animal for slaughter with a view to obtaining a meat product of enhanced nutritional value with regard to polyunsaturated fatty acid is described. The method involves administering to the animal a feed having elevated levels of polyunsaturated fatty acids. The feed includes fatty acids of the C18, n-6 and n-3 series, and the method additionally comprises administering further polyunsaturated fatty acids of the C20 and C22, n-3 series so that the polyunsaturated fatty acid content of the meat is improved and the fat firmness of the meat is maintained in a satisfactory physical condition.

### CROSS REFERENCE TO RELATED APPLICATIONS

This application is a continuation of PCT International Application PCT/GB02/04440, filed Oct. 2, 2002, and published under PCT Article 21(2) in English as WO 03/028474 on Apr. 10, 2003. PCT/GBO2/04440 claimed the priority of British application 0123827.8, filed Oct. 3, 2001. The entire contents of each of the prior applications are incorporated herein by reference.

### FIELD OF THE INVENTION

This invention relates to a method of conditioning animals and particularly for conditioning pigs (although not exclusively) for slaughter by providing an adjusted diet adapted to enhance the polyunsaturated fatty acid characteristics in the carcass fat. Such conditioning may be achieved by a feeding regime adapted to modify and condition the fat of said pigs such that on slaughter the resultant carcass fat comprises a substantially modified fat content in which increased amounts of n-6 and n-3 series polyunsaturated acids are present.

### BACKGROUND OF THE INVENTION

Prior art research has shown that low levels of polyunsaturated fatty acids, n-6 and n-3 series are increasingly being correlated with increases in major health problems and diseases such as coronary heart disease and immune function. This is especially true in the Western World where diets are high in saturated fat essentially due to the large amount of animal fat consumed. Therefore, it was considered that as increased levels of polyunsaturated fats of both n-6 and n-3 series appeared to reduce the risk of such diseases e.g. heart disease, a strategy for increasing the amount thereof in animal fat, to make it more beneficial to the health of the consumer, should be investigated.

Prior art documents investigated the use of increased levels of polyunsaturated fatty acids in pig feed, the consumption of which by the pigs in turn provided an increase in the amount of polyunsaturated fats contained within the pig fat and obviously after slaughter, the carcass fat and resultant pig meat products. However, increasing the polyunsaturated fatty acid levels in the pigs diet did not come without its problems.

It was found that increases in which the major polyunsaturated fatty acid, linoleic acid, exceeded 15% of the total fat, lead to substantial softening of the depot fat and as such any meat products therefrom failed to meet consumer standards in terms of the physical handling of the fat and organoleptic properties. It was therefore found that this was the maximum level to which the polyunsaturated fatty acids, such as linoleic acid, could be increased otherwise the said physical and organoleptic properties were compromised. Standardised pig diets were defined and are used as controls being referred to as “Tallow diet” throughout the application. Using the tallow diet as the feeding regime gave rise to a corresponding level of linoleic acid of 13% in the carcass fat.

Fat firmness is routinely and accurately measured in penetrometer units on a scale 0 (unacceptably soft) to 1000 (unacceptably hard). A fat firmness reading of 575 penetrometer units at 4° C. is considered the limit of acceptability to the consumer. It can be seen from Tables 1 and 2 that the tallow diet provides a carcass fat firmness of approximately 705.0 penetrometer units at 4° C. which is safely above the minimum acceptable limit. However, by continuing to increase the polyunsaturated fatty acids (such as linoleic acid) well beyond that in the tallow diet i.e. exceeding 18% in the diet, and giving rise to a level of some 30% C18:2 linoleic acid in the carcass fat can lead to significant compromise in the softness of the fat (525.0 penetrometer units at 4° C.).

An object of the invention was therefore to provide a method of conditioning an animal for slaughter which comprised administering a feed to provide increased levels of polyunsaturated fatty acids but without the physical and organoleptic properties of the fat being compromised. In this way meat products therefrom would be highly beneficial to health of the consumer whilst being acceptable organoleptically thereto.

### SUMMARY OF THE INVENTION

According to the present invention there is provided a method of conditioning an animal for slaughter with a view to obtaining a meat product of enhanced nutritional value with regard to polyunsaturated fatty acid, which comprises administering to the animal a feed comprising elevated levels of polyunsaturated fatty acids, wherein the feed includes fatty acids of the C18, n-6 and n-3 series, and wherein said method additionally comprises administering further polyunsaturated fatty acids of the C20 and C22, n-3 series, whereby the polyunsaturated fatty acid content of the meat is improved and the fat firmness of the meat is maintained in a satisfactory physical condition.

Preferably the polyunsaturated fatty acid content exceeds 18% of total fat.

Advantageously the C20 and C22, n-3 series long chain polyunsaturated fatty acids are introduced by administering extracts of fish oil, preferably those high in docosahexaenoic (DHA). The extracts of fish oil may be introduced in the range of 0.3%-5%, by weight, of the diet. Preferably the amount is 1%, by weight, of the diet and more preferably the 1% comprises about 14% DHA.

Advantageously the major polyunsaturated fatty acid present is linoleic acid.

According to a further aspect of the invention there is provided a method of modifying the composition of animal fat obtainable in a meat product to enhance the polyunsaturated fatty acid content whilst counteracting the softening of fatty tissue normally associated with enhanced polyunsaturated fatty acid content, said method comprising administering to an animal to be bred for its meat, polyunsaturated fatty acids comprising C18, n-6 and n-3, series and C20 and C22, n-3 series acids.

According to another aspect of the invention there is provided a method of adapting an animal feed for a meat-producing animal, said feed providing polyunsaturated fatty acids for the animal, wherein the animal feed is adapted by including therein C1 8, n-6 and n-3 series, and also C20 and C22, n-3, polyunsaturated fatty acids.

According to an alternative aspect of the invention there is provided a method of adapting an animal feed for a meat-producing animal, said feed providing polyunsaturated fatty acids for the animal including C20 and C22, n-3, fatty acids, wherein the animal feed is adapted by including therein at least one fatty acid precursor capable of yielding a polyunsaturated fatty acid of the C18, n-6 and n-3 series, on consumption of the feed by the meat-producing animal. Preferably the precursor comprises linseed oil.

According to the present invention there is provided a meat product containing polyunsaturated fatty acids of the C18, n-6 and n-3 series, and also C20 and C22, n-3, polyunsaturated fatty acids, said product being obtainable by slaughtering an animal conditioned by a method as previously described. There is further provided a meat product containing polyunsaturated fatty acids of the C18, n-6 and n-3 series, and also C20 and C22, n-3, polyunsaturated fatty acids, said product being obtainable by slaughtering an animal fed with a feed adapted according to a method previously described.

Moreover there is provided pig meat intended for human consumption, and containing nutritionally favourable levels of polyunsaturated fatty acids of the C18, n-6 and n-3 series, and also C20 and C22, n-3, polyunsaturated fatty acids, wherein the polyunsaturated fatty acid content exceeds 18% of total fat in said meat and fat firmness is maintained at an acceptable level. Additionally there is provided pig carcass fat containing enhanced levels of polyunsaturated fatty acids of the C18, n-6 and n-3 series, and also C20 and C22, n-3, polyunsaturated fatty acids, wherein the polyunsaturated fatty acid content exceeds 18% of total fat and fat firmness is maintained at an acceptable level.

Preferably the modified animal fat provided by such a method comprises the ratio of 6:1 n-6/n-3 polyunsaturated fatty acids.

Preferably the linoleic acid is administered in an amount exceeding 18% total fat in the diet.

Moreover the resultant pig carcass fat contains re-structured triacylglycerol species in which the major polyunsaturated fats of both the n-3 and n-6 series are seen to be positioned on the sn-1 and sn-2 position of the triacylglycerol structure. The presence of such polyunsaturated changes give rise to an increased fat firmness associated with the pig fat produced by the present invention.

### BRIEF DESCRIPTION OF THE DRAWINGS

The invention will now be described in greater detail below with reference to the drawing.

FIG. 1. shows a bar graph depicting the effect of diet on the condition of pigs for slaughter, and particularly in respect of the firmness of the back fat measured over the shoulder; (all measurements corrected to 4° C.; each result is the mean±error).

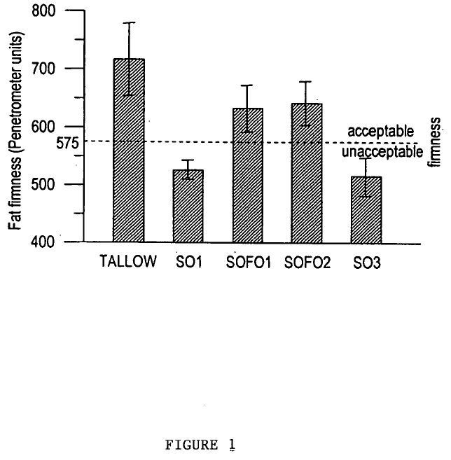

### DETAILED DESCRIPTION OF THE INVENTION

According to the present invention there is provided a method for conditioning an animal for slaughter which comprises administering a feed including enhanced levels of polyunsaturated fatty acids particularly of the C18, n-6 and n-3 series, said method additionally comprising administering an amount of C20 and C22, n-3 series. Prior art documents clearly teach that increasing the linoleic acid level in for example the tallow diet leads to the effects shown by SO1 and SO3 in the graph with fat firmness falling well below the acceptable level at approximately 525 and 510 penetrometer units respectively at 4° C.

However, the applicant found that enhancing the C18 n-6 and n-3 series polyunsaturated fat level whilst simultaneously administering C20 and C22, n-3 series long chain polyunsaturates, unexpectedly led to corresponding increases in the C18 polyunsaturated fat levels in the final carcass and maintenance of the fat firmness consistently above the acceptable level required by consumers. In fact, the fat firmness was not significantly different from that provided by feeding a tallow diet but with the additional health benefits which significantly enhanced C18, C20 and C22 polyunsaturated fatty acid levels provides. This effect in itself is particularly surprising as the C20 and C22, n-3 series long chain polyunsaturated fatty acids have 5 and 6 carbon-carbon double bonds respectively and therefore the addition of more double bonds would be expected to produce carcass fat which is inherently very soft. However this was not found to be the case. The most effective way of introducing C20 and C22, n-3 series polyunsaturated fatty acids to the animal, such as a pig, was by administering extracts of fish oil containing DHA preferably in a range of 0.5%-3%, by weight, of the diet. Advantageously at an amount of 1%, by weight, the fish oil extract comprises about 14% DHA. The invention is expected to offer significant improvements in meat products of non ruminants.

Table 1 shows a comparison of different feed compositions for conditioning pigs for slaughter (all penetrometer measurements at 4° C.). Examples of feed compositions including fish oil are shown as SOFO1 and SOFO2. It can be seen in both Table 1 and the graph that such diets provide both enhanced polyunsaturated fatty acid levels and acceptable fat firmness levels i.e. 645 and 644 penetrometer units respectively measured at 4° C.

TABLE 1

| | STAN- | | | | |
|---|---|---|---|---|---|
| Description | DARD | SO1 | | | S03 |
| (g/kg diet) | Tallow | Prior Art | SOFO1 | SOF02 | Prior Art |
| Barley | 627.2 | 652.7 | 642.5 | 617.0 | 601.7 |
| Soybean Meal | 265 | 265 | 265 | 265 | 265 |
| Dicalcium | 7.8 | 7.3 | 7.5 | 8.0 | 8.3 |
| phosphate | | | | | |
| Fish Meal | 25 | 25 | 25 | 25 | 25 |
| Pig Breeder | 20 | 20 | 20 | 20 | 20 |
| 20E | | | | | |
| Wafolin | 5 | 5 | 5 | 5 | 5 |
| Tallow | 50 | 0 | 0 | 0 | 0 |
| Soybean oil | 0 | 50 | 25 | 50 | 75 |
| Fish oil | 0 | 0 | 10 | 10 | 0 |
| TOTAL FAT | 65.5 | 44.3 | 54.2 | 70.6 | 82.2 |
| in diet | | | | | |
| Linoleic acid | 13.3 | 30.0 | 25.8 | 33.9 | 45.9 |
| present in the | | | | | |
| carcass fat | | | | | |
| FAT | 705.0 | 525.0 | 645.0 | 644.0 | 510.00 |
| HARDNESS* | | | | | |
| (penetrometer | | | | | |
| units) | | | | | |

*575 penetrometer units is considered an acceptable level of firmness and said penetrometer units were measured at 4° C.

Table 2 compares the fatty acid composition and physical properties of pig back fat from pigs fed either a tallow diet or a diet modified according to the invention, in this case SOFO2 (all penetrometer measurements at 1° C.).

TABLE 2

| Parameter | Tallow Diet | Modified Diet |
|---|---|---|
| Saturated - (14:0 + 16:0 + 18:0) | 33.4 | 27.5 |
| Monounsaturated - (16:1n-9 + 18:1n-9) | 50.9 | 36.7 |
| Polyunsaturated - (18:2n-6 + 18:3n-3 + 20:3n-6 + 20:4n-6 + 20:5n- | 15.6 | 35.8 |
| 3 + 22:5n-3 + 22:6n-3) | | |
| Linoleic acid (18:2n-6) | 12.9 | 30.1 |
| C20 + C22 Polyunsaturated fatty acids (n-3) | 0.45 | 1.98 |
| Fat firmness (Penetrometer unit³) | 765.8 | 728.0 |
| (measurements on 0 (‘soft’) to 1000 (‘hard’) scale; values corrected | | |
| to 1° C.) | | |

all fatty acids expressed as g per 100 g total lipid

It is thus seen that the polyunsaturated levels are increased by a significant amount from 15.6 g per 100 g total lipid to 35.8 g per 100 g total lipid in the modified diet. Also it can be seen that commitment reductions in the saturated and monounsaturated fats has occurred. Also, the normally low levels of C20 and C22, n-3 long chain polyunsaturated levels can be seen to have been significantly increased. Such enhanced levels of polyunsaturated fatty acids into the back fat is accompanied by enhanced organoleptic and physical properties thereof. This is confirmed by the substantially similar fat firmness readings of 765.8 and 728 penetrometer units at 1° C., for those pigs fed the tallow and modified diets respectively. Of course, however, the back fat of the pigs fed the modified diet having the significantly enhanced C18, C20 and C22 polyunsaturated fatty acid levels is substantially more beneficial to a consumers health than that of those pigs fed a tallow diet.

As such polyunsaturated enhancement was investigated by way of silver ion high performance liquid chromatography ( as described in WW Christie, Journal of Chromatography 1998, 454:273-284; “Separation of molecular species of triacylglycerol by HPL chromatography with silver ion column”). It was found that pig fat comprised 19 individual molecular triacylglycerol species, 14 of which were identified in compositional terms of palmitic, stearic (major saturates), oleic (major monoenoic), linoleic (major dienoic), alpha-linolenic (major trienoic), docosapentaenoic and docosahexaenoic acids.

Pig fat in pigs fed a tallow diet comprised triacylglycerol molecular species containing a total of 04 double bonds which accounted for 78% of the total lipid whilst molecular species containing 4-6 and 6-10 double bonds accounted for 20% and 2% respectively. However, in a pig feed a modified diet such as SOFO1 and SOFO2 i.e. in accordance with the present invention, molecular species containing a total of 0-4 double bonds only accounted for 57% of total lipid whilst molecular species containing 4-6 and 6-10 double bonds accounted for 38% and 7% respectively. The high levels of polyunsaturation in these pigs fed the modified diets was associated with enhancement and appearance of specific polyunsaturated molecular combinations for which there was evidence of changes intramolecular positional accommodation.

Resultant pig carcass fat has been shown to contain re-structured triacylglycerol species in which the major polyunsaturated fats of both the n-3 and n-6 series are seen to be positioned on the sn-1 and sn-2 position of the triacylglycerol structure. The presence of such polyunsaturated changes gives rise to an increased fat firmness associated with the pig fat produced by the present invention.

Therefore such results demonstrate the advantage of the invention in that in the past enhancement of polyunsaturated fatty acid levels in pig fat was seen to be limited due to deleterious effects on physical properties of the fat, extensive increases to polyunsaturated levels combining both n-6 and n-3 series acids are capable of being performed which are not accompanied by such adverse effects. Evidence is provided that this occurs through the nutritionally enforced synthesis of new molecular species resulting in the incorporation of the C18, C20 and C22, n-3 and n-6 series long chain polyunsaturates into unique triacylglycerol structural arrangements. This involves their esterification into the sn-1 and sn-2 positions of glycerol, compared with normal carcass fat in which esterification is in the sn-3 position.

1. A method of conditioning a meat-producing animal for slaughter
comprising administering to the animal a feed comprising elevated levels of polyunsaturated fatty acids compared to the tallow diet,
wherein the feed includes fatty acids of the c1 8, n-6 and n-3 series, and
wherein said method additionally comprises administering further polyunsaturated fatty acids of the c20 and c22, n-3 series,
whereby the polyunsaturated fatty acid content of the meat is elevated and the fat firmness of said meat is maintained at an acceptable consumer level.

2. A method according to claim 1, wherein the polyunsaturated fatty acid content of said meat exceeds 18% of total fat.

3. A method according to claim 1 wherein the C20 and C22, n-3 polyunsaturated fatty acids are introduced by administering extracts of fish oil, said extracts of fish oil being administered in a range of 0.5%-3%, by weight, in the feed.

4. A method according to claim 3 wherein the extracts of fish oil are administered in an amount of 1%, by weight, in the feed.

5. A method according to claim 3 wherein the extracts of fish oil comprise DHA.

6. A method according to claim 5 wherein the DHA administered in the feed is 14% by weight.

7. A method according to claim 1, wherein the major polyunsaturated fatty acid present is linoleic acid.

8. A method according to claim 1 wherein the animal is a pig.

9. A method of modifying the composition of animal fat in a meat product to enhance the polyunsaturated fatty acid content whilst counteracting the softening of fatty tissue normally associated with enhanced polyunsaturated fatty acid content, said method comprising administering to an animal to be bred for its meat, polyunsaturated fatty acids comprising C18, n-6 and n-3, series and C20 and C22, n-3 series acids.

10. (canceled)

11. (canceled)

12. (canceled)

13. A meat product containing elevated levels of polyunsaturated fatty acids of the C18, n-6 and n-3 series, and also C20 and C22, n-3, polyunsaturated fatty acids compared to a meat product from an animal fed a tallow diet, said product having a fat hardness greater than 575 penetrometer units.

14. (canceled)

15. (canceled)

16. The product according to claim 13, wherein the polyunsaturated fatty acid content exceeds 18% of total fat in said meat product.

17. Pig carcass fat containing enhanced levels of polyunsaturated fatty acids of the C18, n-6 and n-3 series, and also C20 and C22, n-3, polyunsaturated fatty acids, wherein the polyunsaturated fatty acid content exceeds 18% of total fat and fat firmness is greater than 575 penetrometer units.

18. Pig carcass fat according to claim 17 wherein the pig carcass fat contains re-structured triacylglycerol species.

19. Pig carcass fat according to claim 18 wherein the major polyunsaturated fats of both the n-3 and n-6 series are positioned on the sn-1 and sn-2 position of the triacylglycerol structure.

20. The product according to claim 13 wherein the animal is a pig.
